(19) United States
(12) Patent Application Publication
(10) Pub. No.: US 2012/0292306 A1
(43) Pub. Date: Nov. 22, 2012

(54) Floor-Heating Apparatus

(76) Inventor: Tso-Liang LAI, Taichung City (TW)

(21) Appl. No.: 13/300,599

(22) Filed: Nov. 20, 2011

(30) Foreign Application Priority Data
May 17, 2011 (TW) 100117157

(51) Int. Cl. H05B 1/00; H05B 3/06

(52) U.S. Cl. 219/520; 219/482

(57) ABSTRACT

A floor-heating apparatus includes a basic board, a metal sheet and a heater. The basic board is provided on a concrete floor. The metal sheet includes a marking layer provided thereon. The heater is sandwiched between the basic board and the metal sheet so that the heater is located under and therefore marked by the marking layer.

### BACKGROUND OF INVENTION

1. Field of Invention

The present invention relates to a boarded floor and, more particularly, to an apparatus for heating a boarded floor.

2. Related Prior Art

In the interior decoration, boarded floors are popular. Heating of boarded floors is essential for increasing the quality of residence in the cold zone.

Referring to FIG. 1, there is shown at least one basic board 10 attached to a concrete floor A by cement nails (not shown). Then, decorative boards 11 are attached to the basic board 10 by nails 12, with a gap of about 1 cm defined between two adjacent ones of the nails 12. Thus, temperature or humidity could not cause the decorative boards 11 to deform and peel from the basic board 10. This process is however not preferred where there are tiles paved on the concrete floor A.

Referring to FIG. 2, the basic board 10 is paved on the concrete floor A. At least one heater 20 is paved on the basic board 10. At least one protective film 21 is provided on the heater 20. The heater 20 is made with two wires 22 for connection to a power supply. At least one decorative board 11 is paved on the protective film 21. With the heater 20, electricity is converted to heat for heating the interior of a room through the decorative board 11. This practice is not without any problem. At first, the decorative board 11 could be deformed and peeled because it is not attached to the basic board 10 by any nail in fear that the heater 20 might be damaged by such a nail. Secondly, the heater 20 could be scratched and damaged by the decorative board 11 that is moved inevitably by a person walking thereon. Thirdly, there is no protection of the person against electromagnetic waves produced during the operation of the heater 20. Fourthly, the heater 20 is made of PVC or PET that includes a burning point of 80 to 100 degrees Celsius but, at 50 degrees Celsius, starts to release vinyl chloride or plasticizer that is poisonous. Fifthly, the decorative board 11 or the heater 20 would be damaged by overheating if it is covered by an insulating thing such as a quilt.

The present invention is therefore intended to obviate or at least alleviate the problems encountered in prior art.

### SUMMARY OF INVENTION

It is the primary objective of the present invention to provide a heating unit for heating a boarded floor.

To achieve the foregoing objective, the floor-heating apparatus includes a basic board, a metal sheet and a heater. The basic board is provided on a concrete floor. The metal sheet includes a marking layer provided thereon. The heater is sandwiched between the basic board and the metal sheet so that the heater is located under and therefore marked by the marking layer.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a partial, perspective view of a conventional boarded floor;

FIG. 2 is a partial, perspective view of a conventional heating unit for heating the conventional boarded floor shown in FIG. 1;

FIG. 3 is a partial, perspective view of a floor-heating apparatus according to the preferred embodiment of the present invention;

FIG. 4 is an exploded view of the floor-heating apparatus shown in FIG. 3;

FIG. 5 is a perspective view of a concrete floor paved with an array of floor-heating apparatuses as the one shown in FIG. 3;

FIG. 6 is a partial, cross-sectional view of a decorative board and the floor-heating apparatus shown in FIG. 3; and

FIG. 7 is a partial, perspective view of a boarded floor and the floor-heating apparatus shown in FIG. 3.

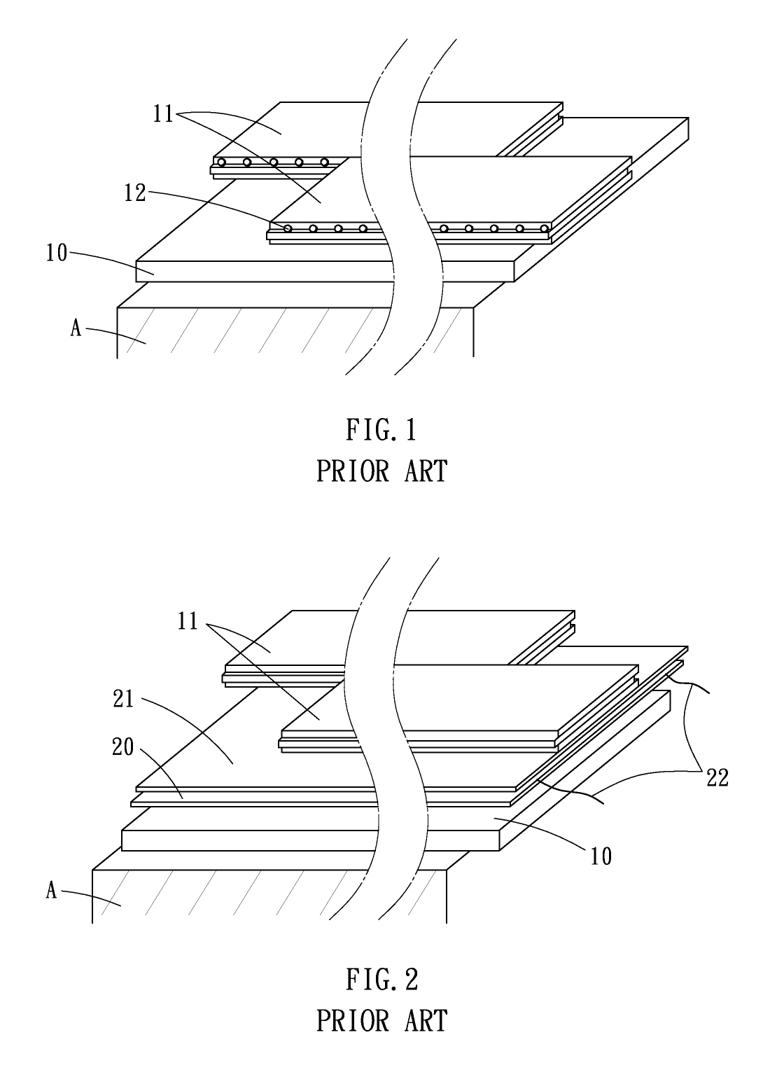

### DETAILED DESCRIPTION OF PREFERRED EMBODIMENT

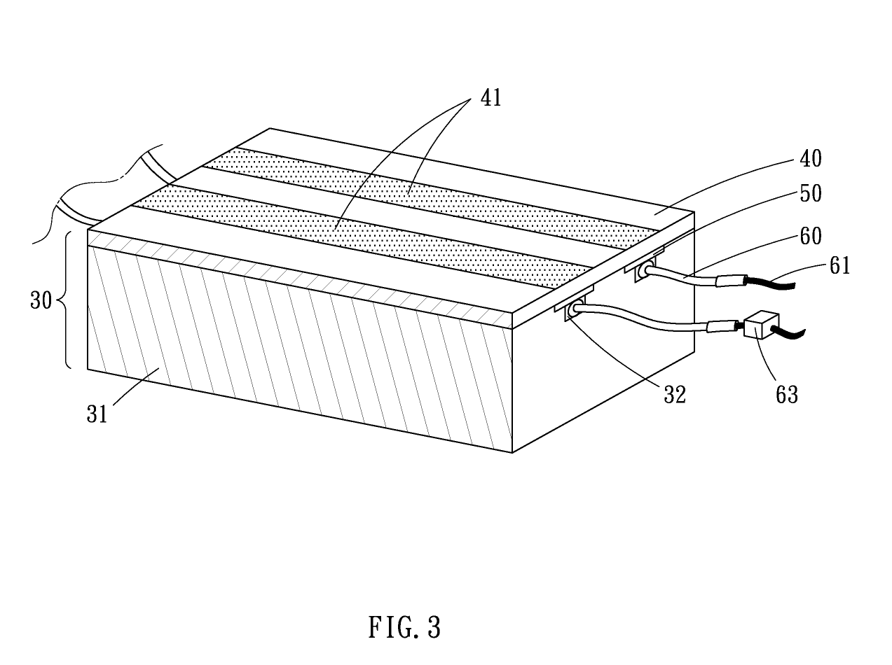

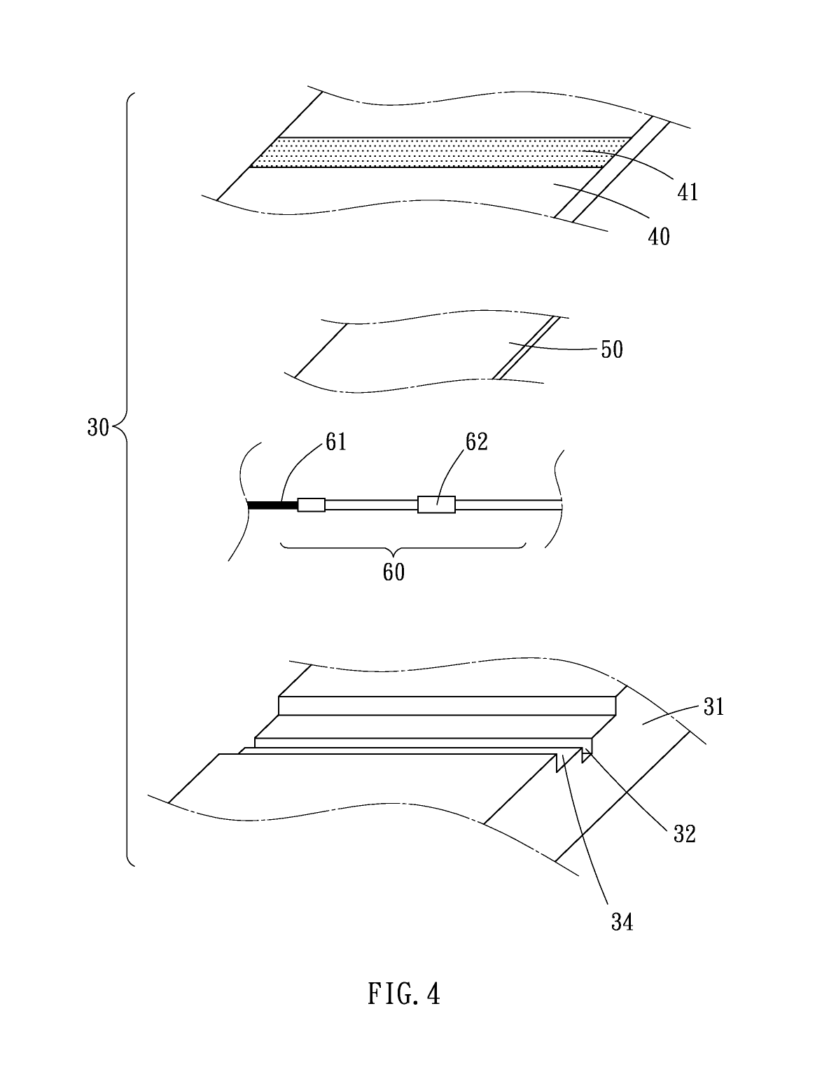

Referring to FIGS. 3 and 4, there is shown a floor-heating apparatus 30 according to the preferred embodiment. The floor-heating apparatus 30 includes a basic board 31, a metal sheet 40, two steel strips 50 and a heater 60. The basic board 31 may be a board of wood, plywood, wood-core plywood, particle wood or the like. The basic board 31 is made with two narrow, deep grooves 32 and two wide, shallow grooves 34. Each of the narrow, deep grooves 32 is located within a related one of the wide, shallow grooves 34.

The heater 60 is used to convert electricity into heat. The heater 60 includes two electric heating wires 61 and temperature-related protecting elements 62. Each of the electric heating wires 61 includes a conductive core wrapped by an isolative sheath. The conductive core may include strands of alloy. The isolative sheath may be made of silicone that stands about 200 degrees Celsius. Thus, the electric heating wires 61 do not release any toxic substance in the range of operation thereof. Each of the electric heating wires 61 is located in a related one of the narrow, deep grooves 32.

Each of the electric heating wires 61 is provided with at least one of the temperature-related protecting elements 62. Temperature-related protecting elements 62 may be temperature sensors.

Each of the steel strips 50 is located in a related one of the wide, shallow grooves 34. Now, each of the steel strips 50 is provided over a related one of the electric heating wires 61. The steel strips 50 are used to shield the electric heating wires 61 against nails.

The metal sheet 40 is provided on the basic board 31 and the steel strips 50. Two marking strips 41 are provided on the metal sheet 40. Each of the marking strips 41 is located above a related one of the electric heating wires 61. The marking strips 41 together make a marking layer.

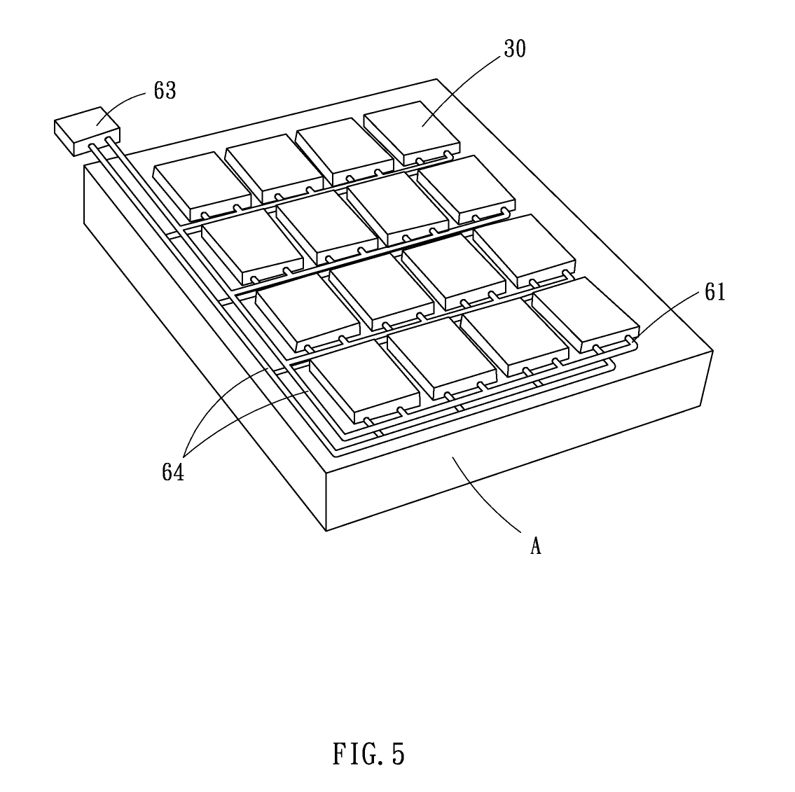

Referring to FIG. 5, there is shown a concrete floor A paved with an array of floor-heating apparatuses 30 electrically connected to a temperature controller 63 through two external wires 64. The temperature controller 63 is used to control the range of temperature in which the heaters 60 of the floor-heating apparatuses 30 are operated.

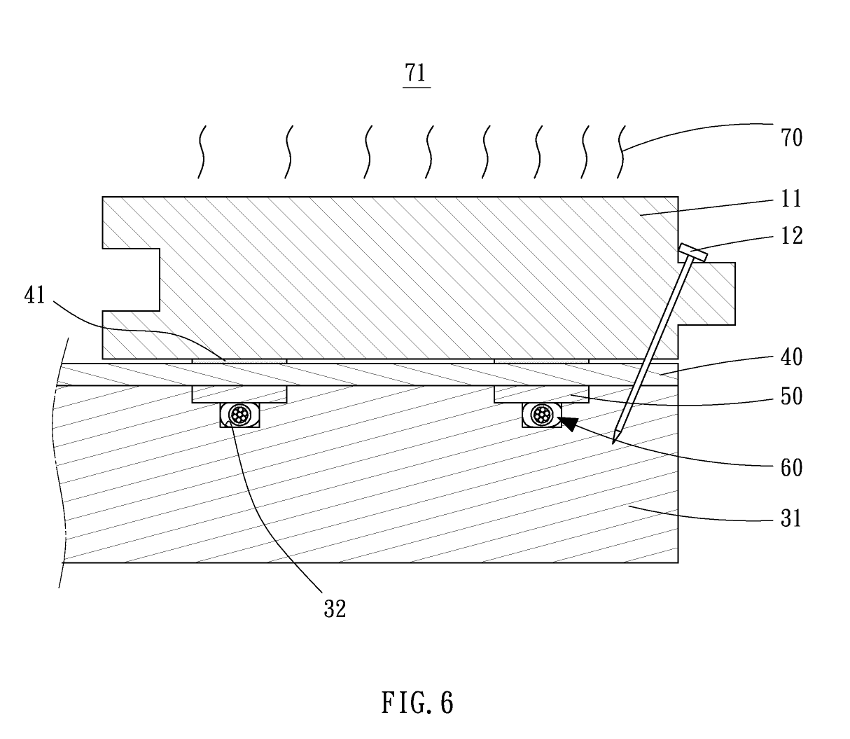

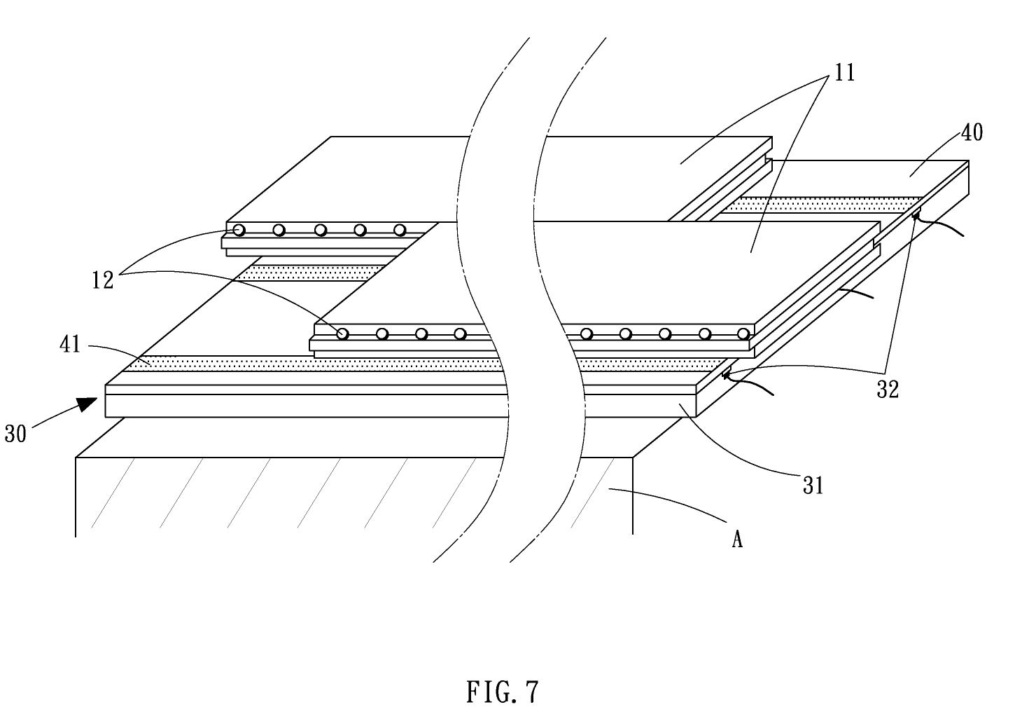

Referring to FIGS. 6 and 7, the basic board 31 is provided on the concrete floor A. Several decorative boards 11 are attached to the basic board 31 by nails 12 inserted through the metal sheet 40. The marking strips 41 are visible during the provision of the nails 12 so that the nails 12 would not be provided on the steel strips 50.

In operation, electricity is converted into heat 70 by the heater 60. The heat 70 is transferred to the decorative boards 11 via the metal sheet 40. The heat 70 is then transferred to the interior of a room 71 from the decorative boards 11. Thus, the room 71 is heated efficiently, effectively and evenly. As described above, in the case of overbeating, each of the floor-heating apparatuses 30 can be turned off independent of the other floor-heating apparatuses 30. The metal sheet 40 is used to transfer the heat 70 to the decorative board 11 from the heater 60. Furthermore, the metal sheet 40 is used to shield electromagnetic waves produced by the heater 60 in operation.

The floor-heating apparatus 30 exhibits several advantageous features. At first, the electric heating wires 61 are marked by the marking strips 41 so that the nails 12 are used to attach the decorative boards 11 to the basic board 31 without having to worry about that the electric heating wires 61 would be damaged by the nails 12.

Secondly, the decorative boards 11 would not be deformed and rubbed against one another to make noises because the former are secured to the later by the nails 12.

Thirdly, the electric heating wires 61 would not be damaged by the decorative boards 11 that is secured to the basic board 31.

Fourthly, the metal sheet 40 shields electromagnetic waves produced during the operation of the heater 60.

Fifthly, the electric heating wires 61 do not release any poisonous substance in the range of operation of thereof.

Sixthly, the decorative boards 11 or the heater 20 would not be damaged by overheating because of the use of the temperature-related protecting elements 62.

Seventhly, the heat 70 is efficiently, effectively and evenly transferred to the decorative boards 11 from the electric heating wires 61 through the metal sheet 40.

Eighthly, the electric heating wires 61 are protected against the nails 12 by the steel strips 50.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A floor-heating apparatus including a basic board, a metal sheet including a marking layer provided thereon, a heater sandwiched between the basic board and the metal sheet so that the heater is located under and therefore marked by the marking layer.

2. The floor-heating apparatus according to claim 1, wherein the heater includes two electric heating wires, wherein the marking layer includes two marking strips each located above a related one of the electric heating wires.

3. The floor-heating apparatus according to claim 2, wherein the basic board includes two narrow, deep grooves each for receiving a related one of the electric heating wires.

4. The floor-heating apparatus according to claim 3, including two steel strips each for shielding a related one of the electric heating wires in the narrow, deep grooves.

5. The floor-heating apparatus according to claim 4, wherein the basic board includes two wide, shallow grooves each for receiving a related one of the steel strips, wherein each of the wide, shallow grooves is in communication with a related one of the narrow, deep grooves.

6. The floor-heating apparatus according to claim 2, wherein the heater includes at least two temperature-related protecting elements each provided on a related one of the electric heating wires.

7. The floor-heating apparatus according to claim 6, wherein the heater includes a temperature controller connected to the electric heating wires.
